(19) United States
(12) Patent Application Publication
(10) Pub. No.: US 2012/0185791 A1
(43) Pub. Date: Jul. 19, 2012

(54) GENERATION OF USER INTERFACES IN THE MANAGEMENT OF PROCESSES WITH ASSOCIATED DATA OBJECTS

(75) Inventors: Shane C. Claussen, Austin, TX (US); Vladimir Klicnik, Oshawa (CA); Dieter Koenig, Herrenberg (DE); Simon D. Moser, Stuttgart (DE); Prabir Nandi, Duluth, GA (US)

(73) Assignee: International Business Machines Corporation, Armonk, NY (US)

(21) Appl. No.: 13/005,578

(22) Filed: Jan. 13, 2011

(51) Int. Cl. G06F 3/048

(52) U.S. Cl. 715/772

(57) ABSTRACT

A method, system, and computer program product for managing a process with one or more associated data objects. The method includes automatically generating, by a computer processor, a user interface configured to allow access and manipulation of each data object from the one or more associated data objects. The access and manipulation may be based on at least a lifecycle state of the data object and a user role. The lifecycle state may be one of a set of states to and from which the lifecycle state can transition.

### BACKGROUND

This invention involves the management of processes and their related data. Specifically, the invention involves generating a user interface using lifecycle and user role information to control the implementation of processes and their related data.

The specification and deployment of business processes and operations is crucial to the successful management of medium or large-scale enterprises. Business Entities provide a basis for specifying business operations that combines data and process at a fundamental level.

Business Entities are business-relevant dynamic conceptual objects that are created, evolved, and (typically) archived as they pass through the operations of an enterprise. A Business Entity includes both an information model for data about the business objects during their lifetime and a lifecycle model, which may describe the possible ways and timings that tasks can be invoked and performed on these objects. An example of a Business Entity type is Courier Shipment, whose information model would include attributes for package ID, sender, recipient, shipping method, arrival times, delivery time, and billing information. The lifecycle model would include the multiple ways that the package could be delivered and paid for, and would be used in tracking each instance of the Courier Shipment Business Entity type. Other examples of Business Entities are a Claim in an Insurance Claims process, going through the states of Filed, Approved, Fulfilled, and so on; Trouble Ticket for a Services Delivery process, going through the lifecycle states of Opened, Assigned, Rejected; financial Deal in a loan-giving organization, going through the lifecycle states of Draft, Offered, Signed, Active, and so on.

Business Entities define a useful way to understand and track business operations, such as the locations that the package has passed through and its arrival times, and the distribution of timings (for example, how many two-day air shipments took longer than two days in the last week) and ways of handling (for example, what percentage of cash-on-delivery shipments required more than one delivery attempt), which are useful for monitoring, dashboards, and more broadly, business intelligence. More generally, Business Entity types can provide a unifying basis for understanding many aspects around the operations of an enterprise, including requirements gathering, business rules, compliance, and process user interactions.

### BRIEF SUMMARY

An example embodiment of the present invention is a method for managing a process with one or more associated data objects. The method may include a generating step for automatically generating, by a computer processor, a user interface configured to allow access and manipulation of each data object based on at least a lifecycle state of the data object and a user role. Each data object may be from the one or more associated data objects. In the example method, the lifecycle state may be one of a set of states to and from which the lifecycle state can transition.

Another example embodiment of the present invention is a system for managing a process with one or more associated data objects. The example system may include a user interface generating module configured to generate a user interface that allows access and manipulation of each data object from the one or more associated data objects. The access and manipulation may be based on at least a lifecycle state of the data object and a user role. The lifecycle state may be one of a set of states to and from which the lifecycle state can transition. The system may also include a computer processor configured to automatically generate the user interface.

Yet another example embodiment of the invention is a computer program product for managing a process with one or more associated data objects. The computer program product may include a computer readable storage medium having computer readable program code embodied therewith. The computer readable program code may be configured to automatically generate, by a computer processor, a user interface configured to allow access and manipulation of each data object from the one or more associated data objects. The access and manipulation may be based on at least a lifecycle state of the data object and a user role. The lifecycle state may be one of a set of states to and from which the lifecycle state can transition.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows an example embodiment of a method for managing a process with one or more associated data objects.

FIG. 2 shows an abstract representation of potential elements of a Business Entity as a Courier Shipment Bill.

FIG. 3 shows the general form of a BEDL document that specifies the properties of a Business Entity.

FIG. 4 shows an example access policy encoded in BEDL through the access policy tag.

FIG. 5 shows an example notification encoded in BEDL through the events tag.

FIG. 6 shows an example Business Entity encoded in BEDL.

FIG. 7 shows an example BPEL document incorporating BEDL elements through the use of the BPEL4data extension.

FIG. 8A shows an example process model in graphical notation, e.g. BPMN, representing a task to be preformed by a night auditor.

FIG. 8B shows an example user interface automatically generated from the example process model of FIG. 8A.

FIG. 9A shows another example of a process model in graphical notation, e.g. BPMN.

FIG. 9B shows an example user interface automatically generated from the example process model of FIG. 9A.

FIG. 10A shows yet another process model in graphical notation, e.g. BPMN.

FIG. 10B shows an example user interface automatically generated from the example process model in FIG. 10A.

FIG. 11 shows an example embodiment of a method that includes a generating step and may additionally include a changing step of changing a data object.

FIG. 12 shows an example embodiment of a method that includes a generating step and may additionally include a listing step and filtering step.

FIG. 13 shows an example embodiment of a method that includes the generating step, listing step and may additionally include a notification step.

FIG. 14 shows an example system for managing a process with one or more associated data objects.

FIG. 15 shows an example system that includes many of the elements of the example system of FIG. 14 but may also include a data updating module.

FIG. 16 shows an example system that includes many of the elements of system of FIG. 14 but may include listing and filtering modules.

FIG. 17 shows an example system that may include many of the elements of example system of FIG. 16 but may also include a notification module.

### DETAILED DESCRIPTION

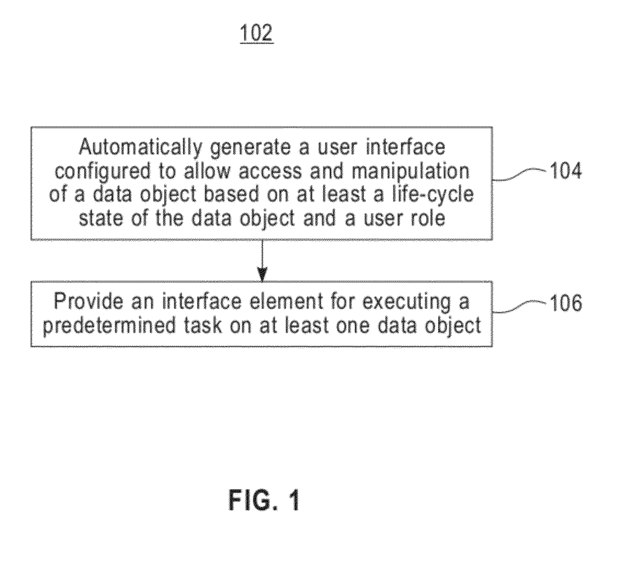

The present invention is described with reference to embodiments of the invention. Throughout the description of the invention reference is made to FIGS. 1-17.

As discussed in detail below, embodiments of the present invention include a method, system, and computer program product to generate a user interface for managing a process with its associated a data objects by utilizing a lifecycle state of a data object and the user role of the user attempting to access the data.

FIG. 1 shows an example embodiment of a method 102 for managing a process with one or more associated data objects. The method 102 may include a generating step 104 for automatically generating, by a computer processor, a user interface configured to allow access and manipulation of each data object based on at least a lifecycle state of the data object and a user role. Each object may be from the one or more associated data objects. In the example method 102, the lifecycle state may be one of a set of states to and from which the lifecycle state can transition.

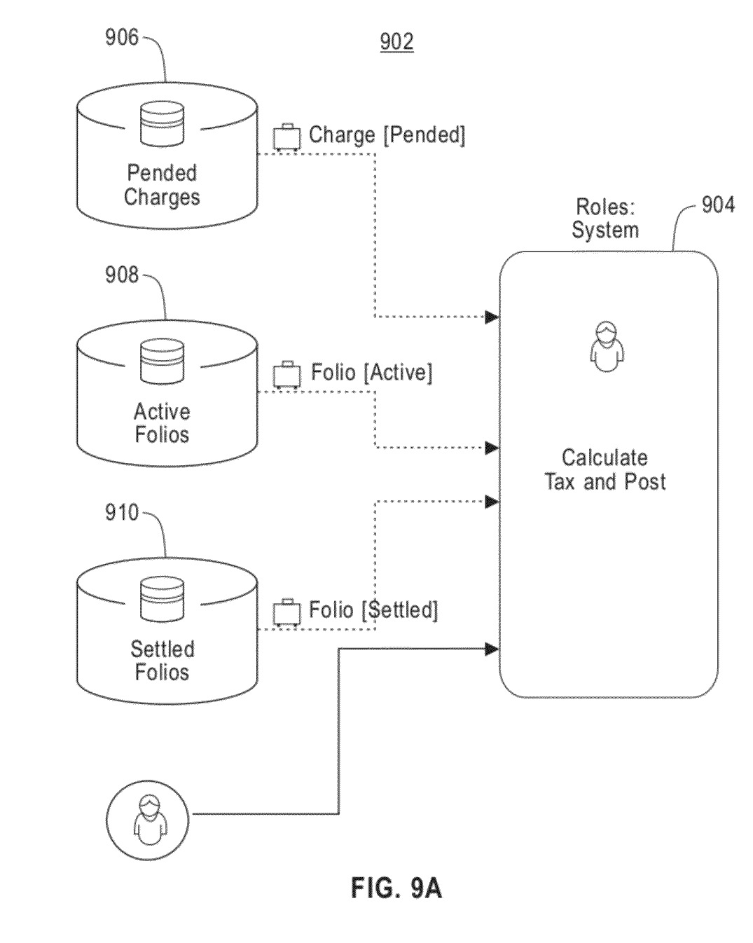

An example method 102 may also include an interface element step 106 for providing an interface element for executing a predetermined task on at least one data object selected from the one or more associated data objects. An example interface element may be a button as shown below in FIGS. 8B, 9B, and 10B. The button 1026 in 10B, for example, is an interface element that facilitates execution of the calculate tax and post task.

To facilitate the method 102 for managing a process with one or more associated data objects, the idea of Business Entities (“BE”) may be introduced and expressed through a Business Entity Definition Language (“BEDL”). In general, when a Business Entity instance is first created, only a fraction of its attributes have values. As the BE instance moves through the enterprise, some attribute values are updated and others are populated. In some cases an attribute might be populated for some but not all of the BE instances of the type. For example, the attribute for Customer Interaction Info might remain un-initialized for shipments by senders who do not contact the shipper after dropping off the package.

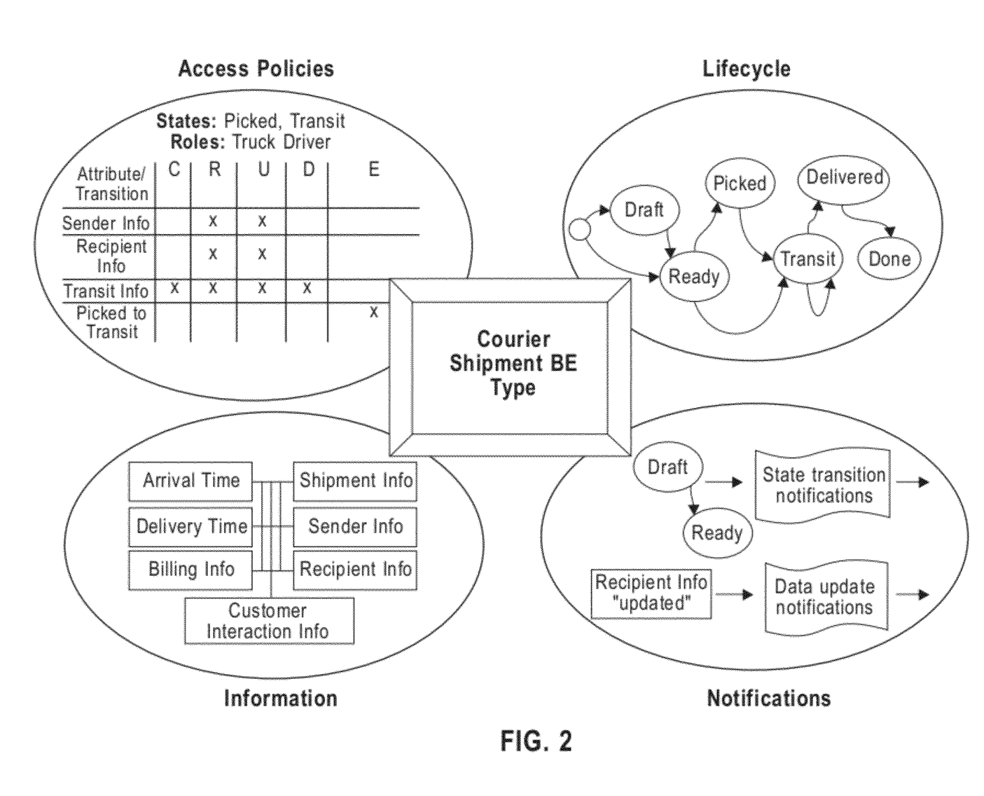

In BEDL, the lifecycle model for Business Entities is specified as a finite state machine. In the lifecycle model for the Courier Shipment BE type of FIG. 2, there are six states along with a unique initial state, which is present in all lifecycle models. FIG. 2 shows an abstract representation the Courier Shipment BE to demonstrate the potential elements of a Business Entity. As shown, a Courier Shipment BE instance can move from the initial state to Draft or to the state Ready. Intuitively, the BE instance can be in the Ready state if the Sender Info and Recipient Info, along with a plan for payment are recorded. The Draft state corresponds to the case where a Courier Shipment is initiated, but there is some delay in getting all of the information needed before moving into the Ready state. The other states and transitions in the lifecycle for the Courier Shipment type are largely self-explanatory. The package might have been brought into a shipping office, in which case the corresponding BE instance will move directly into the Transit state. Otherwise, it will move into the Picked state when it has been picked up from the sender, and then into the Transit state.

Although not illustrated in FIG. 2, directed loops of transitions involving multiple states are permitted. Also, in this state machine model, self-loops are implicit. These arise when a process leaves a BE instance in the same state. This might arise with a Courier Shipment instance, for example, when it is in the Transit state, and information is included about which truck it is on for what time interval and which holding location it is in for what time interval, or which plane it is on, and so on. A self-loop might also arise when new billing information arrives (for example, if the payment processing was COD or performed on monthly basis).

In BEDL, the lifecycle specification itself may not provide detail on the activities that might be performed while a Business Entity instance is in a given state, nor the activities that might be performed as part of transitioning a Business Entity instance from one state to another. A BEDL specification may typically be accompanied by a Web Service Business Process Execution Language or other specification that focuses on the processing aspect of an overall Business Operation Model.

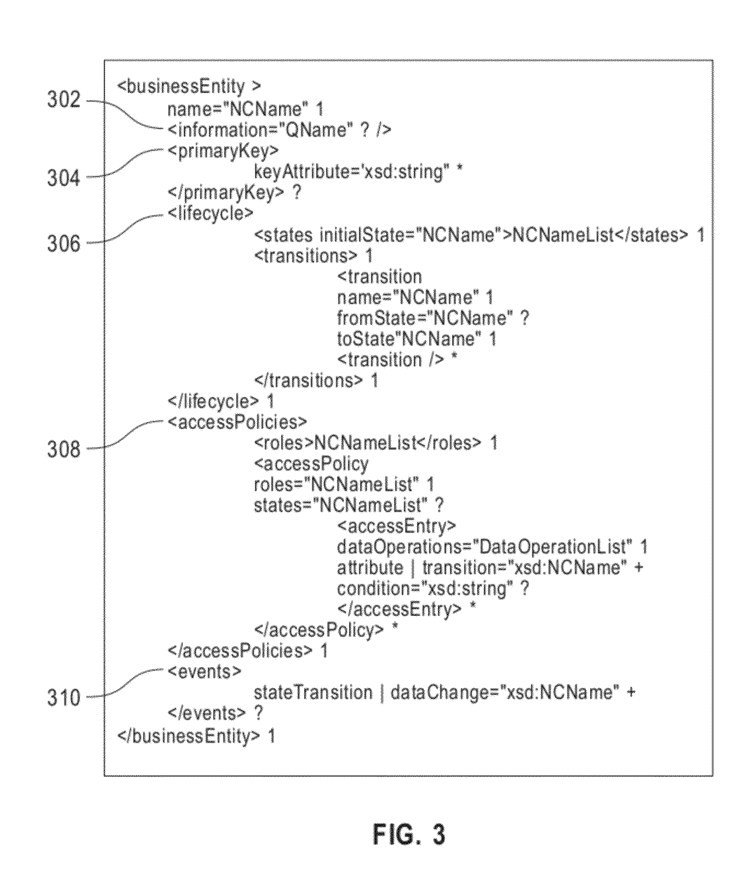

FIG. 3 shows the general form of a BEDL document that specifies the properties of a Business Entity. The cardinality of the various elements can be interpreted as follows: “?” represents zero or one occurrence, “*” represents zero or more occurrences, “+” represents one or more occurrences, and “1” or no specification represents exactly one occurrence.

A Business Entity may contain a lifecycle, an optional reference to an information model, and an optional set of access policies and notifications. The following is a detailed explanation of the various tags that may comprise a Business Entity encoded in BEDL. The information tag 302, may contain a reference to an informational model, potentially encoded in an XML schema. The schema may have attributes and other child elements with the Business Entity type at the root. Those of ordinary skill in the art will recognize a variety of means for storing information in an XML schema.

In the primaryKey tag 304, one or more attributes in the information model can be assigned to the primaryKey list for the BE. Together this attribute or set of attributes may form a unique key for the BE type.

In the lifecycle tag 306, the lifecycle may be represented by a set of states and transition elements. The states may include a flat list of state names with one designated as the initial state. When a BE instance is created, it may transition from the designated initial state into one of the states reachable in one step from the initial state. A transition may have a name, an optional fromState and a toState. If the fromState is unspecified, this indicates that a transition to the toState is allowable from any state. Note that this is purely a convenience feature. However, if there exists a transition for fromState to toState, in addition to a transition element with just the toState, the former may override the latter for all processing purposes.

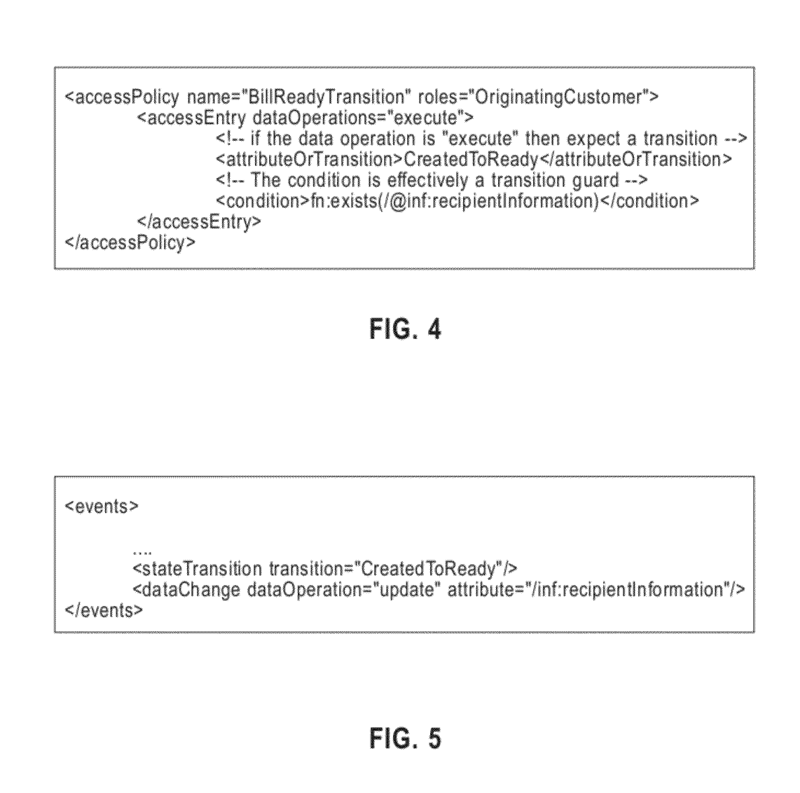

In the access polices tag 308, an access policy may be specified for a set of roles and states. It may contain a set of access entries. An access entry may be a grouping of dataOperations, attributes or transitions, and conditions. The dataOperations may be one of five types: create, read, update, delete and execute. In the case of execute, the target may be a transition that means that this set of transitions is allowed by these roles if the set of conditions are met. Following is an example of an execute access policy. In this example, shown in FIG. 4, the transition CreatedToReady may be allowed only if executed by the OriginatingCustomer role and the condition Recipient Information has a value fn:exists. The default expression language syntax to specify conditions may be XPath/XQuery. For all other dataOperations, the access entry target may be a set of data attributes. One additional nuance may be that only read and update are applicable for simple attributes, whereas for complex attributes, all dataOperations may be applicable.

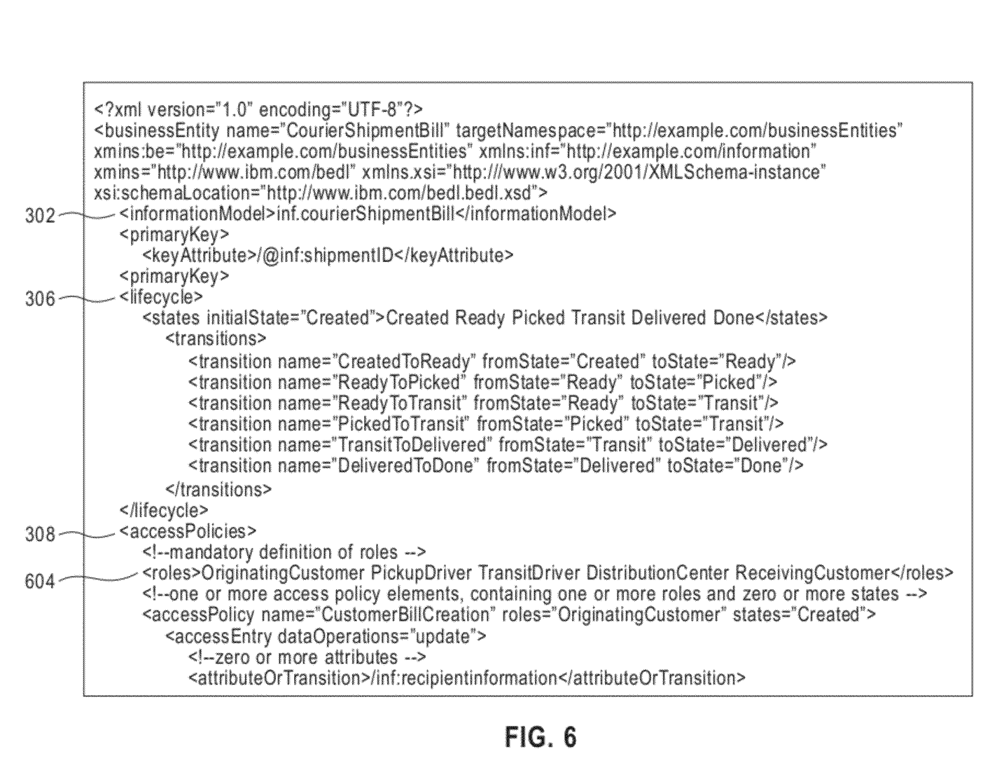

In the events tag 310, notifications may be used to indicate the intent of Business Entities to broadcast to interested parties, a state or data change. Each notification entry may specify a transition or data operation. In case of a data operation, the corresponding data attribute can also be optionally specified. In the example shown in FIG. 5, a notification will be sent whenever the recipientInformation is updated or when the Courier Shipment Bill transitions from the Created to the Ready state.

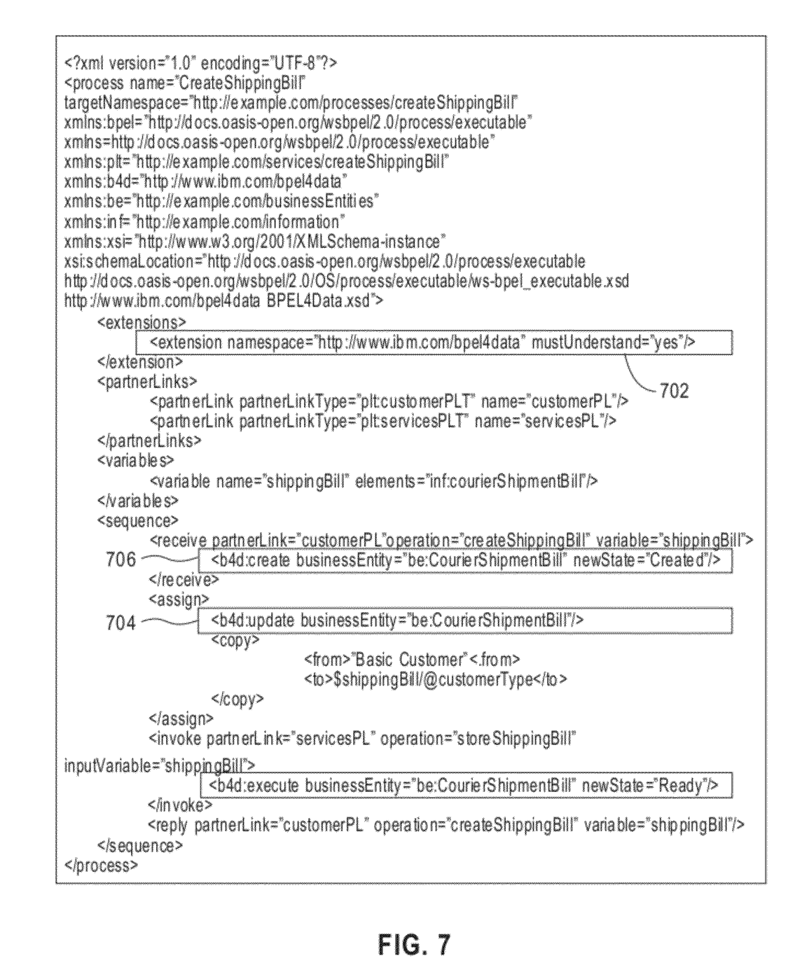

FIG. 6 shows an example Business Entity partially encoded in BEDL. It is an example of how the Courier Shipment Bill Business Entity, depicted abstractly in FIG. 2, may be encoded in BEDL. In this example, the set of user roles may be defined in the roles tag 604. The set of lifecycle states may be defined under the lifecycle tag 306. The plurality of object rules may be defined in the access policies tag 308. The notifications may be defined in the events tag 310. These elements may be associated with a data object through the information model tag 302.

These Business Entities encoded in BEDL may be managed through a set of processes using a Business Process execution language (“BPEL”), which may be extended to incorporate a computer markup language such as BEDL. One type of BPEL is called Web Service Business Process Execution Language (“WS-BPEL”). One example of using WS-BPEL and extending it to incorporate a computer markup language is through the use of BPEL4data. BPEL4data may extend WS-BPEL to incorporate Business Entities encoded in BEDL. BPEL4Data is a declarative extension to WS-BPEL that has been developed so that WS-BPEL processes can work easily with BE definitions expressed in BEDL. BPEL4Data may contain the extensions to WS-BPEL to formally consume BEDL elements. Specifically, it may provide a declarative syntax for annotating a WS-BPEL activity to either specify a BE state change or to indicate BE content manipulation. Those of ordinary skill in the art will recognize that similar techniques may be applied to a variety of BPEL languages incorporating a computer markup language with the functionality described above.

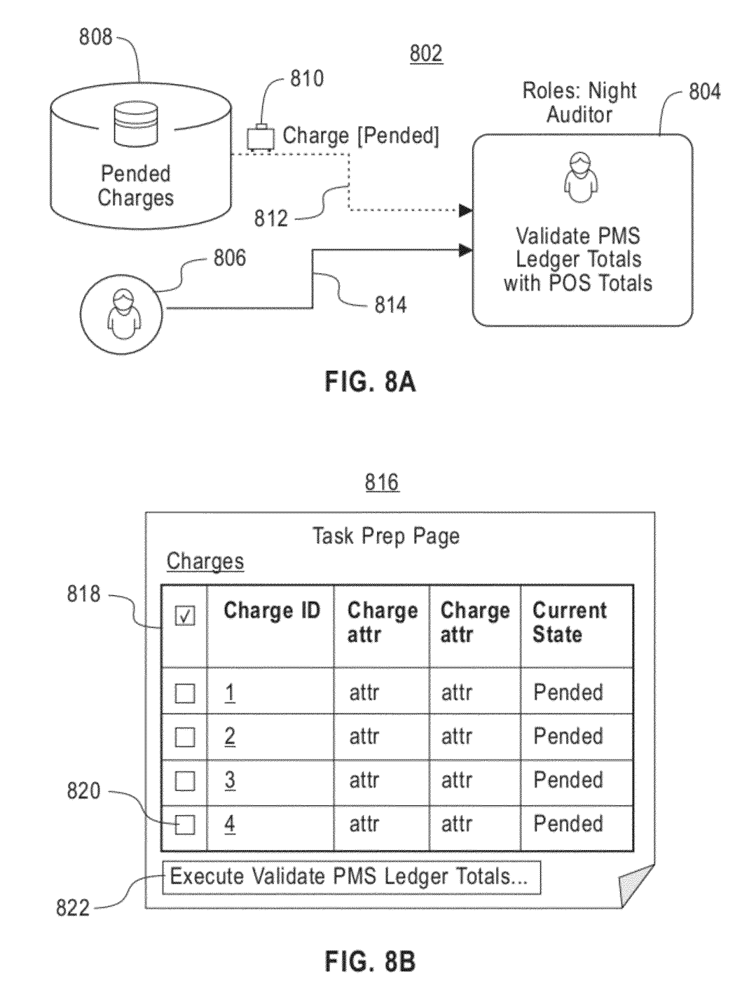

FIG. 7 shows a sample WS-BPEL document incorporating BEDL elements through the use of the BPEL4data extension. The boxed segments of code in the figure indicate lines of code using the BPEL4data extension. The extension tag 702 may extend WS-BPEL to include statements made in BPEL4data. The b4d tag 704 may be used to incorporate Business Entities encoded in BEDL. The create command 706 is used, for example, to create a new BE called Courier Shipment Bill, which is given an initial lifecycle state of Created. As shown in FIG. 7, various other functions such as the update and execute commands may be used and appreciated by those of ordinary skill in the art.

In the generating step 104 of the example method 102 of FIG. 1, the user interface may be configured to allow access and manipulation according to the access policies of a Business Entity. There may be two focus areas for these policies: CRUD in connection with Creates, Reads, Updates, and Deletes of attribute values in the information model, and Executions of state transitions in the lifecycle model. We sometimes refer to the collection of these two types of access policies as CRUDE policies.

The CRUD restrictions may focus on what roles have authority to modify attribute values. These restrictions may be keyed not only by attribute and role, but also by the state that a BE instance is in. You can see this in FIG. 2, where the CRUD matrix for the role TruckDriver is shown for the states Picked and Transit. Although not illustrated in FIG. 2, a CRUD restriction may also include a guard, or condition, expressed in XPath, based on the attribute values of the BE instance. For example, a TruckDriver might be permitted to update the Sender Info only if the Transit Info indicates that the truck is scheduled to go, or has gone, to the sender's address. The CRUD restrictions may be enforced in connection with processes that attempt to access BE instance attributes, and also in connection with notifications in response to subscriptions.

Similar to the CRUD policies, the Execution policies may involve two components. First, an Execution policy may specify which transitions can be invoked by a given role. Second, similar to a CRUD policy, an Execution policy may include a guard, or condition, that must be satisfied in order to transition from one state to another. For example, it may be specified that a Courier Shipment instance cannot move to the Ready state unless the Sender Info and Recipient Info are populated.

The user interface of method 102 may include one or more data fields displaying data pertaining to at least one data object selected from the one or more data objects. The data may be editable depending on at least the lifecycle state of the data object and the user role. In the automatic generation of the user interface, the computer processor may follow an algorithm that determines from the process model the Business Entities and user role involved in a task.

A basic example algorithm for automatically generating a user interface based on Business Entities is as follows. For all human tasks, if the input of the task is connected to at least one Business Entity store, then generate “List Page(s)” to allow the user to select Business Entities from each Business Entity store. In addition (or in the alternative), generate “Search Page(s)” to allow users to search for Business Entity instances. Both of the above pages may be filtered by the state tag to the BE store by default.

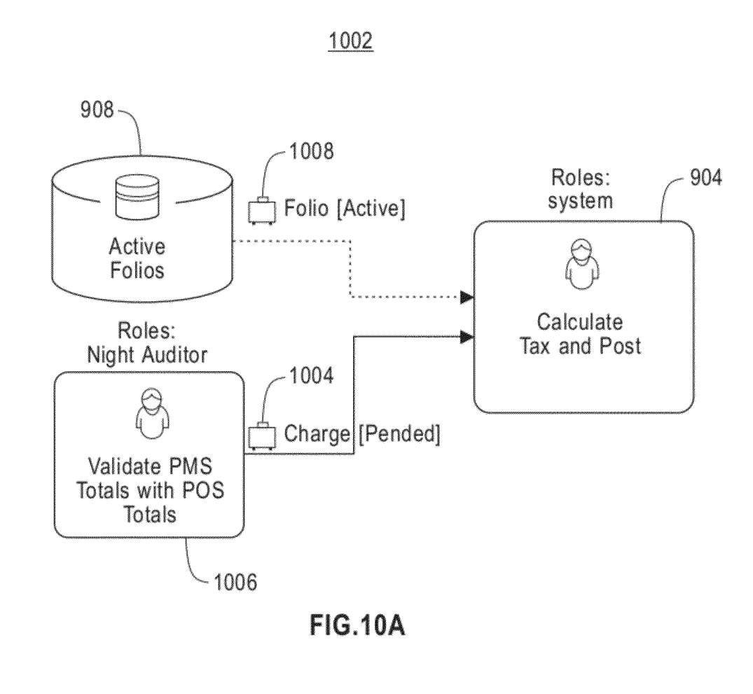

Next, generate the classic human task user interface page(s). During this process, data fields may be generated as editable or not based on a set of access policies of the Business Entities. Also, add a button to save ad hoc updates. The button may generate errors based on access policy enforcement. If the task changes the Business Entity state, add alerts to show data inconsistency failures and page(s) to allow for fixing. Also, add alerts to show lifecycle validation exceptions. Optionally, add pages for compensation task execution. Those of ordinary skill in the art will recognize that a variety of ways in various computer languages to accomplish this algorithm. In FIG. 10B, explained below, an example user interface shows editable data fields 1022 and read-only data fields 1020 according to the functionality described.

In example method 102, each data object from the one or more associated data objects may also have a set of attributes. The set of attributes may include the lifecycle state. Each data object, which may be organized as a Business Entity, may include different attributes depending on the nature and use of the Business Entity. As shown in FIG. 2, some example attributes of a data object organized as a Business Entity may include information, lifecycle states, current lifecycle state, name, and access policies describing when information may be accessed according to the current lifecycle state and user role associated with performing a process with the Business Entity.

In example method 102, the user interface may be based on a process model in graphical notation. FIGS. 8-10 show example embodiments of process models (FIGS. 8A, 9A, 10A) in a graphical notation and example user interfaces (FIGS. 8B, 9B, and 10B) generated from the process models. These examples all pertain to the management of a hotel and may include: 1) folios (data objects organized as Business Entities) with individual customer information and charges and 2) tasks such as posting charges to a folio. The following process models may represent individual tasks and associated data objects that are part of a larger system of tasks in the management of a hotel.

FIG. 8A shows an example process model 802 in graphical notation representing a task to be preformed by a night auditor. In this example model 802, the rounded square 804 represents a task to be performed of validating property management system ledger totals with point of sale totals. The circle with a human FIG. 806 may indicate a particular user that initiates the performance of the task. The cylinder 808 may represent a repository of Business Entities. A briefcase 810 may represent individual Business Entities. In example process model 802, the Business Entities are charges in the pended lifecycle state (i.e., those which have not been added to a customer's folio yet). The dotted arrow 812 indicates that charges from the repository may be accessed and manipulated during the validation task. The fact the arrow is dotted may indicate that one or more of the entities from the repository may be used during the task. The solid arrow 814 from the circle 806 to the rounded square 804 may indicate that a single user is selected to perform the task. From the process model, one or more user interfaces may be automatically generated. The example validation task requires at least two phases and each may require a unique user interface. The first phase of the example validation task is the preparation phase, and the second phase of the example validation task is the execution phase.

A full human task execution process to be managed through a user interface may include three phases: the preparation phase, execution phase, and completion phase. An example implementation may begin by posting a task to the task list of a user. Then, the user claims a task, and the user role is automatically ascertained. This step may lead to a preparation phase with a new dialogue or user interface. If the claimed task is associated with a store of Business Entities, the user interface may show a list of Business Entities and their lifecycle states. There may be a separate list for each type of Business Entity. In addition, the user interface may allow the user to search for Business Entities pre-filtered by state. While on the user interface, the user may select one or more Business Entities from the list. Task variables may be instantiated from the selected Business Entity data.

Next, a new user interface may be generated for the execution phase. In this phase, the user may perform task logic through forms rendering task variables. In the generation of the user interface, data fields may be rendered editable (or not) based on access policy. The user interface may also allow the user to update and save data (ad hoc repetitions may be allowed). The Business Entity stores may be kept in synch with updates.

Upon task completion, the user interface may enter a completion phase. During this phase, the user may be prompted to confirm task completion. If the task changed the state of the BE, the user interface may check to see if the state change is allowed based on the lifecycle. If the state change is not allowable, the user is alerted and asked to take remedial actions (e.g., compensation). Optionally, the compensation may be executed and the user interface returns to the completion phase. Additionally, after the change of state of the BE, the user interface may check for data inconsistencies (execute rules or guard conditions). Inconsistencies may be produced, for example, if another user changed the Business Entity during the time after the first user selected the Business Entity. If there are inconsistencies, the user is alerted of the inconsistencies and asked to fix them. For these changes, control may return to an execution phase user interface until fixed. Finally, the Business Entity may undergo a state change, and control may be returned to the process engine. Those of ordinary skill in the art will recognize that these phases may be accomplished in a variety of ways including through multiple user interfaces or through multiple dialogues in one user interface.

FIG. 8B shows an example user interface 816 automatically generated from the example process model 802 for a preparation phase of the validation task. During the preparation phase, the example user interface 816 may include a list 818 of the Business Entities (in this case, charges in the pended lifecycle state) that may be selected in order to perform the validation task. Checkboxes 820 may be toggled between the states of checked and unchecked to select Business Entities upon which the task will be performed. The example user interface 816 shows columns listing attributes. Though the general term “Charge attr” and “attr” are shown, these are meant to represent customer charge attributes and attributes, respectively, specific to the Business Entities being listed. One of the attributes may include the current lifecycle state of the Business Entity. In this example user interface 816, four customer charges are listed, all of which are in the pended state because they are taken from the repository of pended charges 808. The example user interface 816 may also include a button 822 that initiates the generation of the next user interface as part of the execution phase to allow changes and execution of the task upon the selected charges.

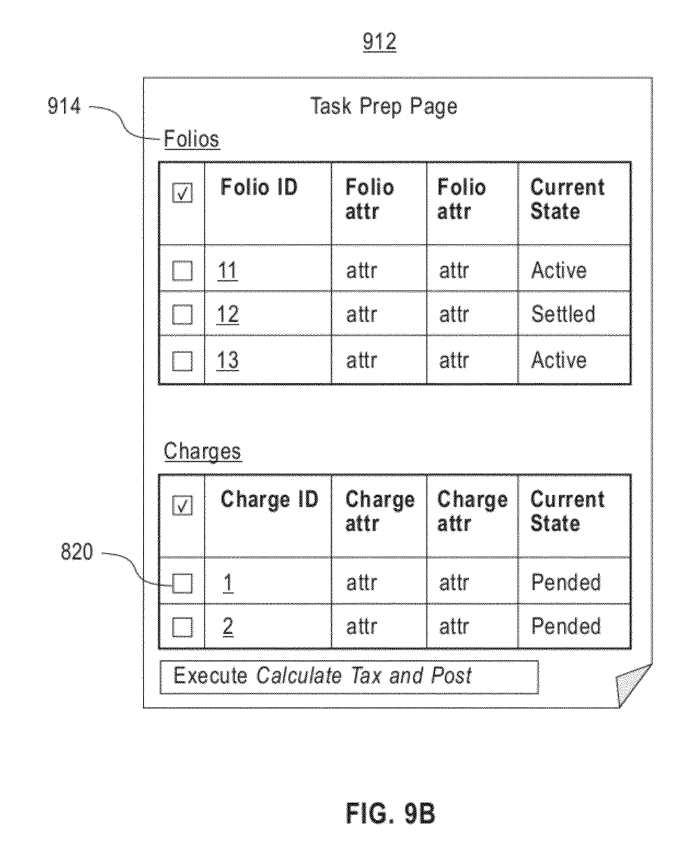

FIG. 9A shows another example process model 902 in graphical notation. This example process model 902 shows another task that may be part of the management of a motel. The graphical notation is explained above, but unlike the example in FIG. 8A, this example process model 902 may represent the calculate tax and post task 904, which draws Business Entitles from multiple repositories. Similar to the example in FIG. 8A, there may be a pended charges repository 906, but there may also be a repository for folios in the active state 908 and a repository for folios in the settled state 910.

FIG. 9B shows an example user interface 912 automatically generated from the example process model 902 of FIG. 9A. Because the calculate tax and post task 904 draws from two different kinds of Business Entities, which may have different attributes (though they all may include a lifecycle state), they are listed under separate headings 914. Though the folios come from two different repositories, they may be listed under the same heading 914 with an indication of the lifecycle state of each. Those of ordinary skill in the art will recognize a variety of ways for displaying Business Entities in such a way to enable process management.

FIG. 10A shows yet another process model 1002 in graphical notation that is part of a hotel process management system. This process model is in the same graphical notations as the examples of FIGS. 8A and 9A but shows that a task may receive a Business Entity from another task as well as from a repository. In this example, the calculate tax and post task 904 receives one charge 1004 that has been previously selected during the validate process management system totals and point of sale totals task 1006. The calculate tax and post task 904 also receives an active folio 1008 from the active folio repository 908. This example may represent a hotel employee taking a charge in the pended lifecycle state, then calculating tax on that charge, and posting the charge and its tax on the active folio of the customer who is being charged.

FIG. 10B shows an example user interface 1010 automatically generated from the process model 1002 in FIG. 10A. The example user interface 1010 may list the folios 1012 to which a charge 1014 may be applied. Each of these folios may be selectable through a checkbox 820 as described above. The charge 1014 is also listed with attributes 1016 and corresponding data fields 1018. Some data fields may be editable and some may be read only, depending on the task and the user role of the entity performing the task. In example user interface 1010, the customer first name data field 1020 is read only, while the charge items data field 1022 is writable, allowing the user to provide details explaining the charge. Changes may be performed upon the charge 2 Business Entity by clicking the save button 1024. Additionally, the calculate tax and post task 904 may be brought to the execution phase of the process by clicking the calculate tax and post button 1026.

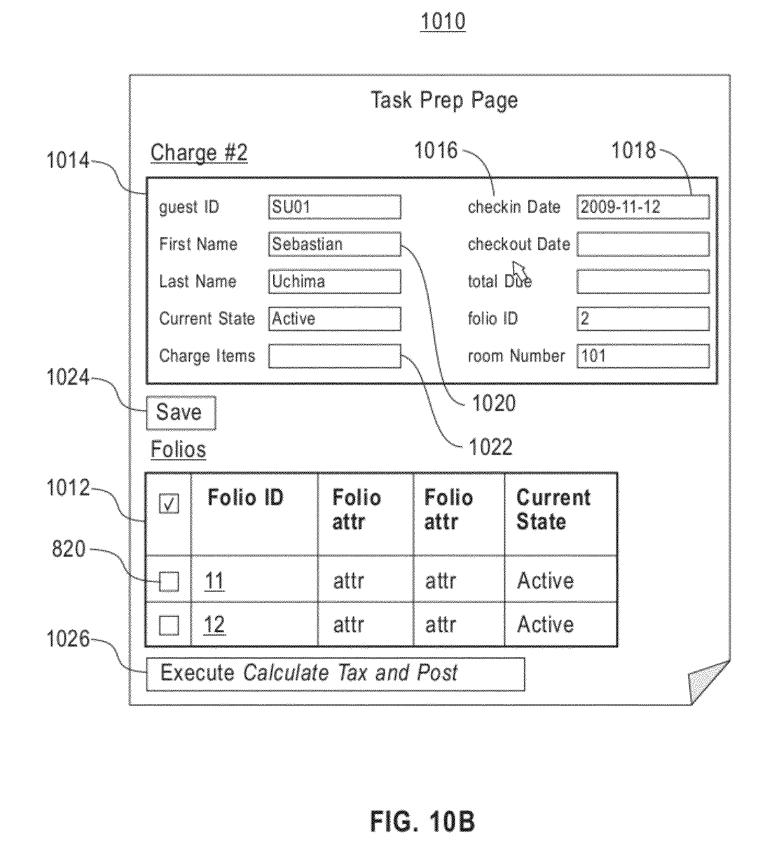

FIG. 11 shows an example embodiment of a method 1102 that includes the generating step 104 and may additionally include a changing step 1104 of changing a data object included in the one or more data objects. The changing of the data object may be based on input received through the user interface. FIG. 10B, for example, shows editable data fields that allow a user to input or change data stored in the data object organized as a Business Entity. As mentioned above, changes to the data object may be enacted by clicking the save button 1024 as shown in FIG. 10B. Examples of changes to a data object may include creating, updating, deleting, and transitioning the data objection from one lifecycle state to another. Changes to the data object may be subject to access policies as described above.

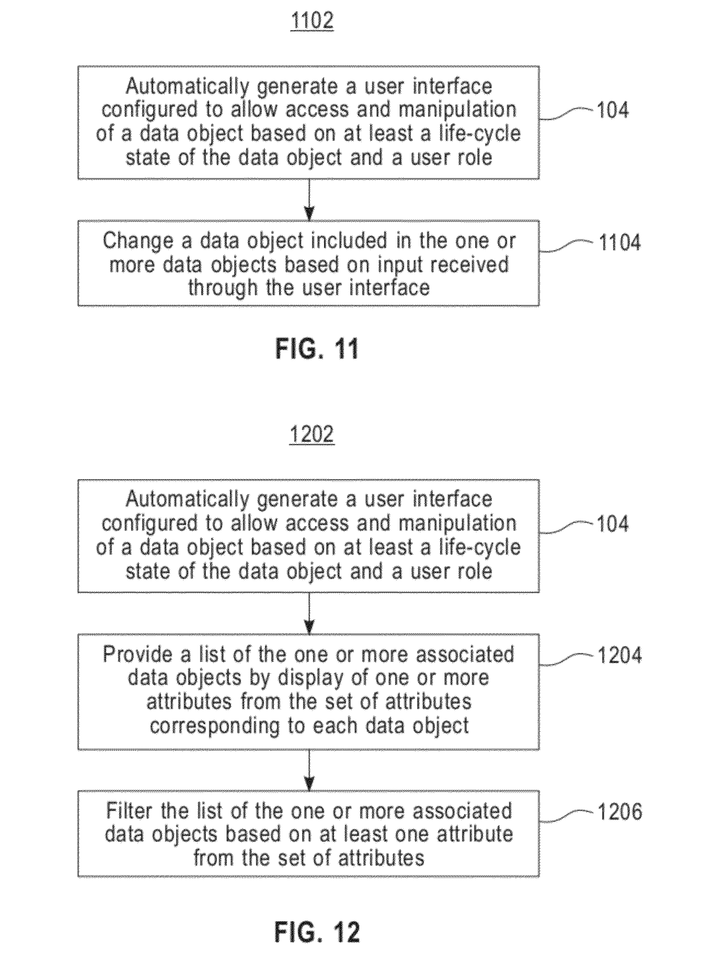

FIG. 12 shows an example method 1202 that includes the generating step 104 and may additionally include a listing step 1204 of providing a list of the one or more associated data objects by display of one or more attributes. The one or more attributes may be from the set of attributes corresponding to each data object from the list of one or more associated data objects. FIGS. 8B, 9B, and 10B show example lists of data objects. FIG. 9B, for example, shows two lists, each organized under a heading 914 of folios or charges. Additionally, each data object may be selectable through functionality described above. Example method 1202 may also include a filtering step 1206 of filtering the list of the one or more associated data objects based on at least one attribute from the set of attributes. Those of ordinary skill in the art will recognize a variety of ways for filtering the contents of a list. Although FIG. 12 shows both a listing step 1204 and a filtering step 1206, some embodiments may contain only one of the two steps.

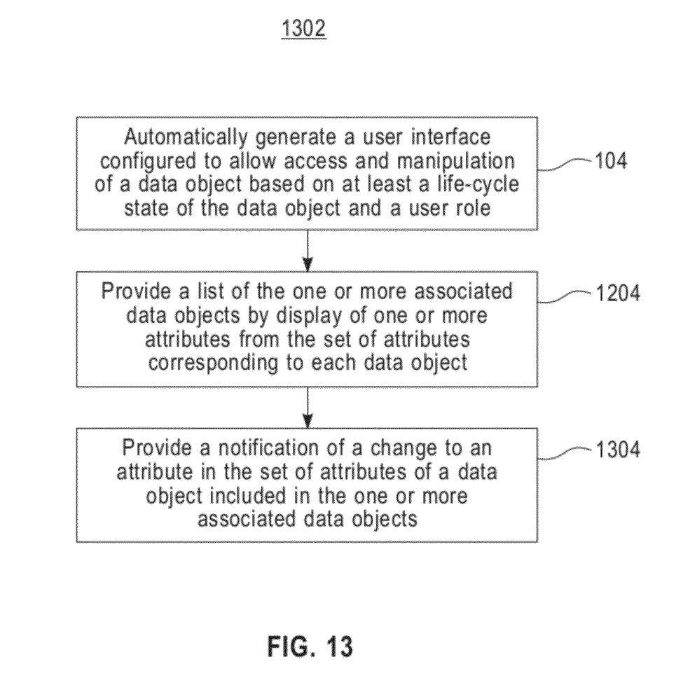

FIG. 13 shows an example embodiment of a method 1302 that includes the generating step 104, listing step 1202 and may additionally include a notification step 1304 of providing a notification of a change to an attribute. The attribute may be one of a set of attributes of a data object included in the one or more associated data objects. In one embodiment, a notification may be a pop-up window that alerts the user to a problem. Notifications relevant to a data object may be implemented through the events tag of a Business Entity encoded in BEDL as described above.

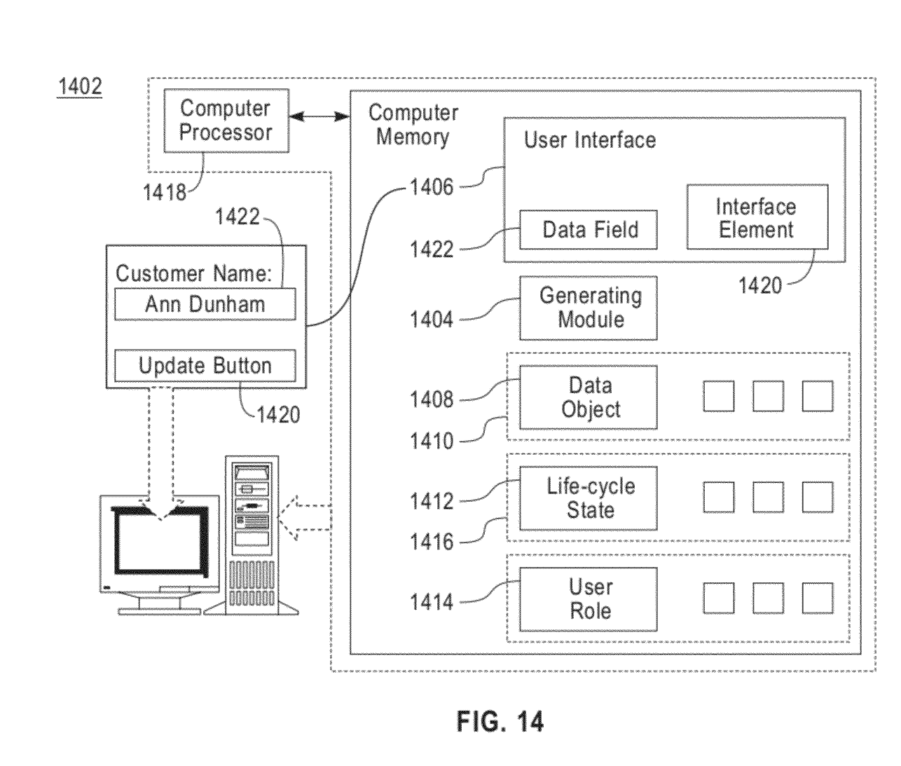

FIG. 14 shows an example system 1402 for managing a process with one or more associated data objects. The example system may include a user interface generating module 1404 configured to generate a user interface 1406 that allows access and manipulation of each data object 1408 from the one or more associated data objects 1410. The access and manipulation may be based on at least a lifecycle state 1412 of the data object and a 1414 user role. The lifecycle state 1412 may be one of a set of states 1416 to and from which the lifecycle state can transition. The system 1402 may also include a computer processor 1418 configured to automatically generate the user interface 1406. The example system 1402 may be implemented using Business Entities through BEDL along with WS-BPEL explained above. The user interface may be, for example, an executable program or a window in an executable program. One embodiment of the user interface may be a web page incorporating one or more script languages such as PHP, ASP, JavaScript, Perl, or CSS. Those of ordinary skill in the art will recognize a variety of ways to implement the example system 1402.

The example system 1402 may also include an interface element 1420 for executing a predetermined task on at least one data object 1408 selected from the one or more associated data objects 1410. An interface element in one embodiment may be a clickable button. The interface element 1420 may be part of the user interface 1406. The user interface 1406 may also include one or more data fields 1422 displaying data pertaining to at least one data object 1408 selected from the one or more associated data objects 1410. The data may be editable depending on at least the lifecycle state 1412 of the data object 1408 and the user role 1414. Additionally, the user interface may be based on a process model in graphical notation. FIGS. 7A, 8A, and 9A are example process models in graphical notation.

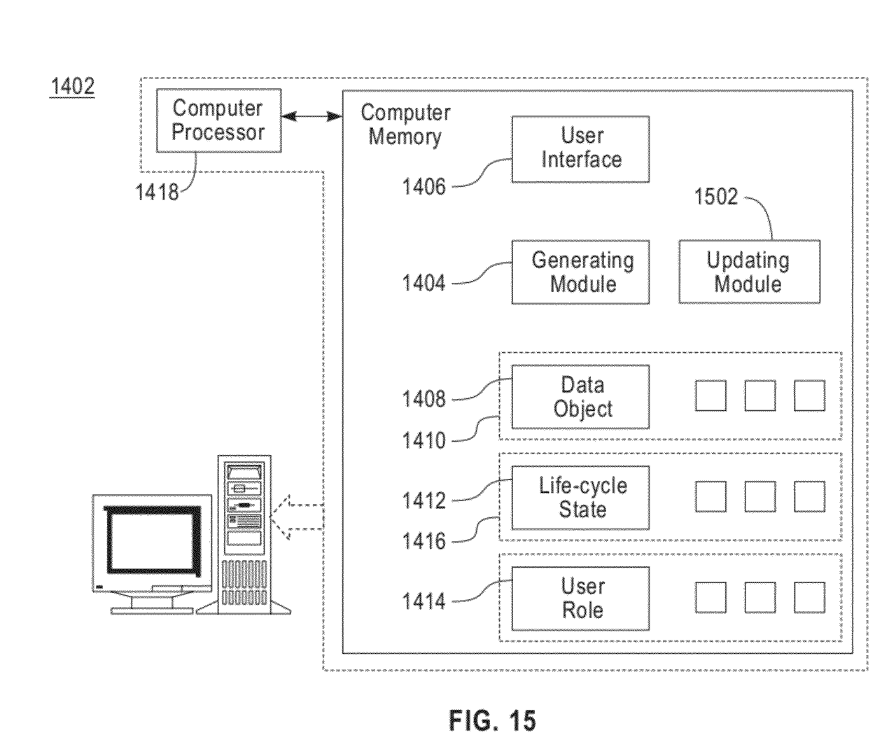

FIG. 15 shows an example system 1502 that includes many of the elements of system 1402 but may also include a data updating module 1502 configured to change a data object 1408 included in the one or more associated data objects 1410 based on input received through the user interface 1406. In one embodiment, data objects may be changed through an implementation of Business Entities encoded in BEDL as described above.

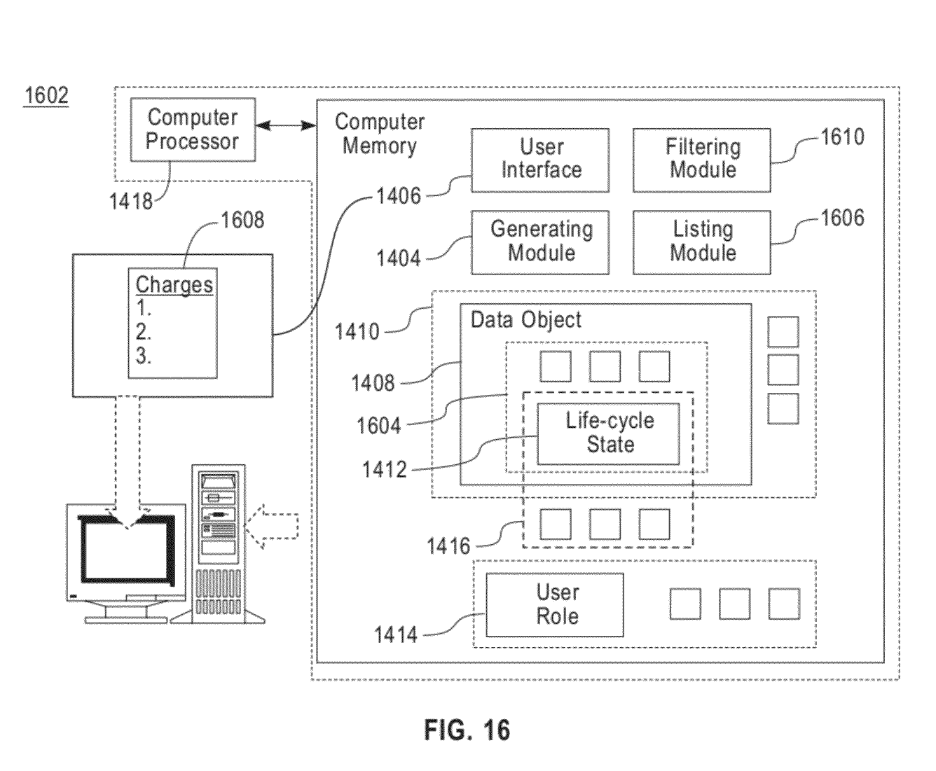

FIG. 16 shows an example system 1602 that includes many of the elements of system 1402 but each data object 1408 from the one or more associated data objects 1410 may have a set of attributes 1604, including the lifecycle state 1412. In one embodiment, these attributes may be stored as Business Entities encoded in BEDL as described above. The example system 1602 may include a listing module 1606 that provides a list 1608 of the one or more associated data objects 1410 by display of one or more attributes from the set of attributes 1604 corresponding to each data object 1408 from the one or more associated data objects 1410. Additionally, each data object may be selectable. FIGS. 8B, 9B, and 10B are examples of displaying a list of selectable data objects. FIG. 9B, for example, shows two lists of data objects each with a heading 914 identifying the type of data object followed by rows of data objects, each with a checkbox. The checkboxes 820, for example, may be toggled on and off by the click of a mouse to indicate that a data object has been selected.

The example system 1602 may also include a filtering module 1610 that provides a list 1608 of the one or more associated data objects 1408 filtered by at least one attribute from the set of attributes 1604. In one embodiment, the user may filter a list of data objects in different lifecycle states to a list of data objects with only one lifecycle state. Those of ordinary skill in the art will recognize a variety of ways for filtering the contents of a list. Though FIG. 16 shows both a listing module 1606 and a filtering module 1610, some embodiments may contain only one of the two modules.

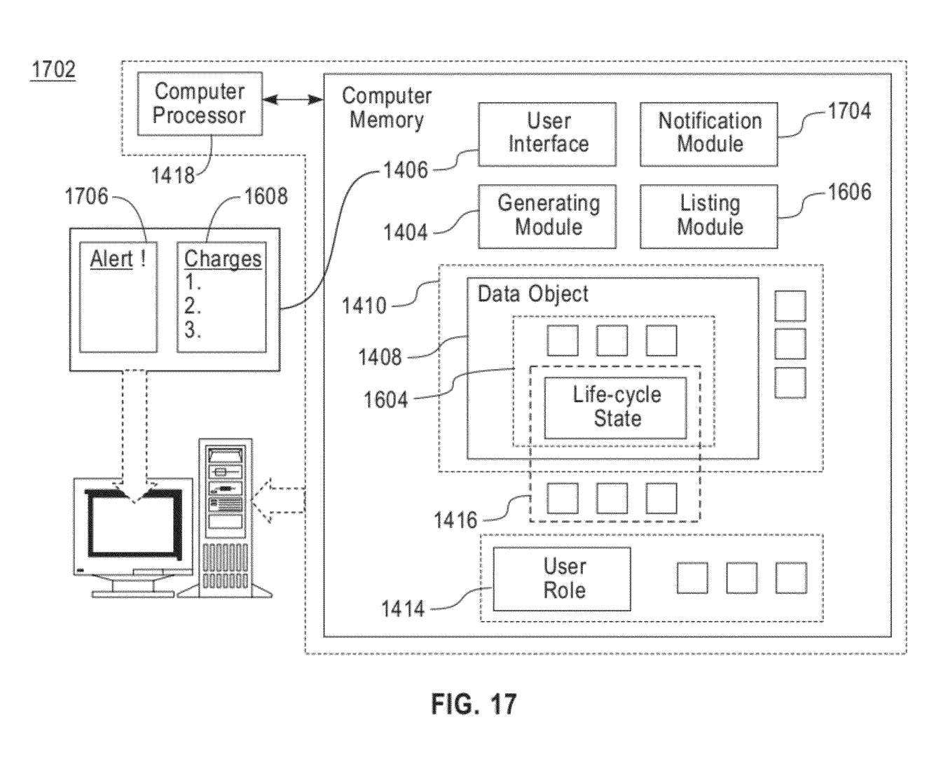

FIG. 17 shows an example system 1702 that may include many of the elements of example system 1602 but may also include a notification module 1704 configured to provide a notification 1706 of a change to an attribute in the set of attributes 1604 of a data object 1408, which is included in the one or more associated data objects 1410. In one embodiment, a notification 1706 may be a pop-up window that alerts the user to a problem. Notifications relevant to a data object may be implemented through the events tag of a Business Entity encoded in BEDL as described above.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preferred embodiments to the invention have been described, it will be understood that those skilled in the art, both now and in the future, may make various improvements and enhancements that fall within the scope of the claims which follow. These claims should be construed to maintain the proper protection for the invention first described.

What is claimed is:

1. A method for managing a process with one or more associated data objects, comprising:
automatically generating, by a computer processor, a user interface configured to allow access and manipulation of each data object from the one or more associated data objects based on at least a lifecycle state of the data object and a user role; and
wherein the lifecycle state is one of a set of states to and from which the lifecycle state can transition.

2. The method according to claim 1, further comprising:
providing an interface element for executing a predetermined task on at least one data object selected from the one or more associated data objects.

3. The method according to claim 1, wherein the user interface includes one or more data fields displaying data pertaining to at least one data object selected from the one or more data objects, the data being editable depending on at least the lifecycle state of the data object and the user role.

4. The method according to claim 1, further comprising:
changing a data object included in the one or more data objects based on input received through the user interface.

5. The method according to claim 1, wherein each data object from the one or more associated data objects has a set of attributes, including the lifecycle state; and
providing a list of the one or more associated data objects by display of one or more attributes from the set of attributes corresponding to each data object from the list of one or more associated data objects, each data object being selectable.

6. The method according to claim 5, further comprising:
filtering the list of the one or more associated data objects based on at least one attribute from the set of attributes.

7. The method according to claim 5, further comprising:
providing a notification of a change to an attribute in the set of attributes of a data object included in the one or more associated data objects.

8. The method according to claim 1, wherein the user interface is based on a process model in graphical notation.

9. A system for managing a process with one or more associated data objects, comprising:
a user interface generating module configured to generate a user interface that allows access and manipulation of each data object from the one or more associated data objects based on at least a lifecycle state of the data object and a user role, wherein the lifecycle state is one of a set of states to and from which the lifecycle state can transition; and
a computer processor configured to automatically generate the user interface.

10. The system according to claim 9, further comprising:
an interface element for executing a predetermined task on at least one data object selected from the one or more associated data objects.

11. The system according to claim 9, wherein the user interface includes one or more data fields displaying data pertaining to at least one data object selected from the one or more associated data objects, the data being editable depending on at least the lifecycle state of the data object and the user role.

12. The system according to claim 9, further comprising:
a data updating module configured to change a data object included in the one or more associated data objects based on input received through the user interface.

13. The system according to claim 9, wherein each data object from the one or more associated data objects has a set of attributes, including the lifecycle state; and
a listing module that provides a list of the one or more associated data objects by display of one or more attributes from the set of attributes corresponding to each data object from the one or more associated data objects, each data object being selectable.

14. The system according to claim 13, further comprising:
a filtering module that provides a list of the one or more associated data objects filtered by at least one attribute from the set of attributes.

15. The system according to claim 13, further comprising:
a notification module configured to provide a notification of a change to an attribute in the set of attributes of a data object included in the one or more associated data objects.

16. The system according to claim 9, wherein the user interface is based on a process model in graphical notation.

17. A computer program product for managing a process with one or more associated data objects, the computer program product comprising:
a computer readable storage medium having computer readable program code embodied therewith, the computer readable program code configured to:
automatically generate, by a computer processor, a user interface configured to allow access and manipulation of each data object from the one or more associated data objects based on at least a lifecycle state of the data object and a user role; and
wherein the lifecycle state is one of a set of states to and from which the lifecycle state can transition.

18. The computer program product of claim 17, wherein the computer readable program code is further configured to:
provide an interface element for executing a predetermined task on at least one data object selected from the one or more associated data objects.

19. The computer program product of claim 17, wherein the user interface includes one or more data fields displaying data pertaining to at least one data object selected from the one or more data objects, the data being editable depending on at least the lifecycle state of the data object and the user role.

20. The computer program product of claim 17, wherein the computer readable program code is further configured to:
change a data object included in the one or more data objects based on input received through the user interface.
